(19) United States
(12) Patent Application Publication
(10) Pub. No.: US 2010/0245129 A1
(43) Pub. Date: Sep. 30, 2010

(54) System and method for identifying machines

(75) Inventor: Kenneth Lee Stratton, Dunlap, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 12/384,070

(22) Filed: Mar. 31, 2009

(51) Int. Cl. G08G 1/01

(52) U.S. Cl. 340/933

(57) ABSTRACT

A system and method for identifying modifications made to a machine is disclosed. The method may include determining, by a scanning device, at least one actual dimension of the machine. The method may further include determining at least one previously known dimension of the machine. The method may further include comparing the at least one actual dimension of the machine with the at least one previously known dimension of the machine. The method may further include determining, based on the comparison, if the at least one actual dimension of the machine is within a threshold range of the at least one previously known dimension of the machine.

### TECHNICAL FIELD

The present disclosure relates generally to identifying machines, and more particularly to a system and method for identifying machines and modifications made to machines.

### BACKGROUND

Mining and excavating operations may require fleets of machines to transport excavated material (e.g., dirt, rocks, gravel, etc.) from an area of excavation to a secondary location. In some cases, mining and excavating operations are performed in harsh environments and/or extremely remote locations, where the use of conventional machine systems that employ human operators is prohibitively expensive or otherwise impractical. In such environments, it may be advantageous to employ machines that may be equipped for autonomous operation (i.e., machines that do not require an on-board human operator).

In some environments, autonomously operated machines may be required to operate relatively close to each other. For example, in a mining environment, an autonomously operated dozer may come to a stop at a cross in the road to allow for an off-highway truck to cross in front of the autonomously operated dozer. To prevent operational conflicts, the autonomously operated dozer may be equipped with an obstacle detection and/or collision avoidance system to detect when the off-highway truck has completely passed and, consequently, when it is appropriate for the dozer to re-initiate travel along the road.

A collision avoidance system is disclosed in U.S. Pat. No. 7,167,799 (the '799 patent), issued to Dolgov et al. The '799 patent discloses a collision avoidance system and method that uses a Global Positioning Satellite (GPS) system to determine geographic coordinates of two vehicles. The '799 patent further discloses using a centrally located processor to determine the position of the vehicles by, for example, comparing the geographic coordinates of the vehicles with geographic coordinates in a mapping system associated with the centrally located processor. The centrally located processor then uses the geographical location of a first vehicle to mathematically model and solve a collision avoidance domain. The centrally located processor uses information corresponding to the solved collision avoidance domain to alert an operator of an obstruction(s), e.g., another vehicle, in the first vehicle's path.

The collision avoidance system and method disclosed in the '799 patent may decrease the likelihood of collisions between vehicles, in certain situations. However, GPS systems, such as the one employed in the '799 patent, typically monitor the relative position of the GPS unit with respect to a satellite, without regard for the size, type, or dimension of the machine on which it is employed. Consequently, collision avoidance systems that rely solely on GPS position systems may not adequately differentiate between large objects and small objects. Accordingly, modifications to the dimensions of a machine may not be accurately and reliably detected and/or accounted for by the collision avoidance system and method disclosed in the '799 patent. For example, as described previously, if the off-highway truck is towing a trailer, a collision avoidance system as used in the '799 patent coupled to the autonomously operated dozer may not know when the off-highway truck has completely passed since the trailer coupled to the dozer has changed the overall dimensions associated with the dozer. Therefore, a system and method for identifying machines and modifications made to machines may be desirable.

The disclosed system and method is directed toward improving systems and methods for identifying machines and modifications made to machines.

### SUMMARY

In one aspect, the present disclosure is directed to a method for identifying modifications made to a machine. The method may include determining, by a scanning device, at least one actual dimension of the machine. The method may further include determining at least one previously known dimension of the machine. The method may further include comparing the at least one actual dimension of the machine with the at least one previously known dimension of the machine. The method may further include determining, based on the comparison, if the at least one actual dimension of the machine is within a threshold range of the at least one previously known dimension of the machine.

In another aspect, the present disclosure is directed to a system for identifying modifications made to a machine. The system may include a scanning device configured to scan the machine to determine at least one actual dimension of the machine. The system may further include a database in communication with the scanning device, the database configured to store at least one previously known dimension of the machine. The system may further include a Central Processing Unit (CPU) in communication with the scanning device and the database. The CPU may be configured to compare the at least one actual dimension of the machine with the at least one previously known dimension of the machine. The CPU may further be configured to determine, based on the comparison, if the at least one actual dimension of the machine is within a threshold range of the at least one previously known dimension of the machine.

In yet another aspect, the present disclosure is directed to a worksite configured to identify modifications made to machines. The worksite may include a plurality of machines. The worksite may further include a scanning device configured to scan each of the plurality of machines to determine at least one actual dimension of each of the plurality of machines. The worksite may further include a database associated with the scanning device, the database configured to store at least one previously known dimension of each of the plurality of machines. The worksite may further include a Central Processing Unit (CPU) associated with the scanning device and the database. The CPU may be configured to compare the at least one actual dimension of at least one of the plurality of machines with the at least one previously known dimension of the at least one of the plurality of machines. The CPU may further be configured to determine, based on the comparison, for the at least one of the plurality of machines, if the at least one actual dimension of the at least one of the plurality of machines is within a threshold range of the at least one previously known dimension of the at least one of the plurality of machines.

### BRIEF DESCRIPTION OF THE DRAWINGS

FIG. 1 is a diagrammatic illustration of exemplary disclosed machine;

FIG. 2 is a diagrammatic illustration of an exemplary disclosed worksite for the machine of FIG. 1;

FIG. 3 is an exemplary disclosed system for identifying machines and modifications made to machines which may be associated with the worksite of FIG. 2; and

FIG. 4 is an exemplary method for identifying the machine of FIG. 1 and modifications made to the machine in FIG. 1, and updating other machines with the modifications.

### DETAILED DESCRIPTION

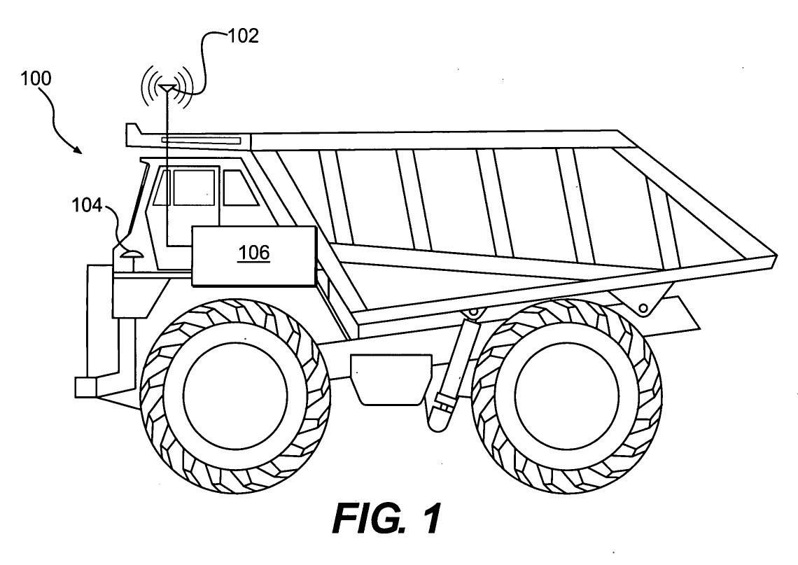

FIG. 1 illustrates an exemplary machine 100. Machine 100 may include any on-highway or off-highway machine that may be deployed within a worksite. As illustrated in FIG. 1, machine 100 may embody an off-highway haul truck for transporting materials about the worksite. Although machine 100 is illustrated as an off-highway truck, machine 100 may be any type of machine that performs some type of operation associated with an industry such as mining, construction, farming, transportation, etc. For example, machine 100 may be an earthmoving machine such as, for example, an excavator, a loader, a backhoe, a tractor, a dozer, and the like. Additionally, although machine 100 is illustrated as a mobile machine, it is contemplated that machine 100 may embody stationary machines or objects that may be deployed within a worksite such as, for example, a generator or a trailer.

In the embodiment of FIG. 1, machine 100 may comprise a wireless communication device 102, a GPS antenna 104, and a controller 106. Wireless communication device 102 may comprise one or more wireless devices configured to send and/or receive wireless communications to and/or from remote locations. For example, machine 100 may use wireless communication device 102 to wirelessly exchange information with other machines, and/or a remote site such as, for example, a control center of a worksite. GPS antenna 104 may comprise one or more wireless devices configured to receive information indicative of a position of machine 100 from a plurality of Global Positioning Satellites. Although wireless communication device 102 and GPS antenna 104 are illustrated as being two separate elements, it is contemplated that they may be combined into one element, if desired.

Controller 106 may comprise a system of one or more electronic control modules configured to receive and/or exchange information indicative of modifications made to machine 100 and/or other machines at a worksite via wireless communication device 102. Controller 106 may include one or more computer mapping systems (not shown). The computer mapping system(s) may comprise tables, graphs, and/or equations for use in a collision avoidance system. For example, the computer mapping system(s) may comprise the dimensions of machine 100 and other machines at a worksite, topographical and geographical information of a worksite, and desired and current position and orientation of machine 100 and/or other machines at a worksite. It is contemplated that the tables, graphs, and/or equations in the computer mapping system(s) may be updated via wireless communication device 102, and/or any other suitable communication device.

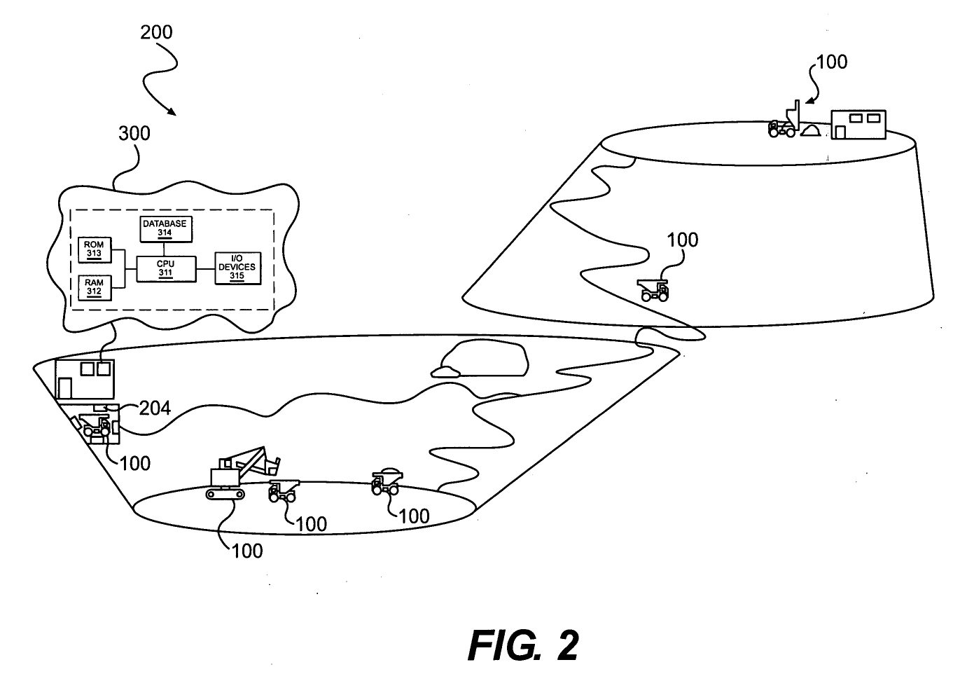

FIG. 2 illustrates an exemplary worksite 200, in which exemplary systems and methods for identifying machine 100 and modifications made to machine 100 may be implemented. As illustrated in FIG. 2, worksite 200 may embody an automated or semi-automated mine site. It is contemplated, however, that the embodiments described herein may be implemented in any type of work environment where it may be advantageous to monitor the identity and modifications of machines and equipment that enter a worksite. Worksite 200 may include a plurality of machines 100 cooperating to perform a task associated with worksite 200. Worksite 200 may include autonomous machines (i.e., machines that may be operated and controlled by on-board, automated electronic and mechanical systems), remotely-controlled machines (i.e., machines that are operated and controlled by a human or a computerized entity located off-board of the machine), operator-driven machines (i.e., machines that are controlled and operated by conventional, human operators located in a cab onboard the machine), or a combination of autonomous, remotely-controlled, or operator-driven machines.

Because worksite 200 may include autonomous machines that may be driven, in some cases, without a human operator, such machines may be equipped with a worksite awareness system to monitor and control various aspects of worksite 200 and the machines operating therein. The worksite awareness system may include an obstacle detection and/or a collision avoidance system that can accurately detect the boundaries and travel paths of worksite 200, and the location of stationary and mobile machines or equipment at worksite 200. In this way, machine 100 may be effectively operated and maneuvered autonomously at worksite 200.

To supplement the worksite awareness system, worksite 200 may include a scanning device 204 and a computing system 300. Scanning device 204 and computing system 300 may be configured to cooperate to identify the size and type of machines operating within worksite 200, and modifications associated therewith. Scanning device 204 and computing system 300 may further be configured to update machines at worksite 200 to the actual size and type of machines operating within worksite 200.

Scanning device 204 may be configured to scan machine 100 as machine 100 enters worksite 200, and transmit the results of the scan to computing system 300 so that computing system 300 can determine the size and type of machine 100 (and modifications associated therewith) operating within worksite 200. In one embodiment, scanning device 204 may be configured to scan all or part of machine 100 using devices that emit electromagnetic radiation. For example, it is contemplated that scanning device 204 may scan machine 100 using, for example, radio waves, microwaves, infrared radiation, optical scanning technology, LIDAR, radar, and the like. Scanning device 204 may then transmit information indicative of a propagation of the electromagnetic wave used to scan machine 100 to computing system 300, where the information may be analyzed to determine the actual dimensions of machine 100.

In another embodiment, scanning device 204 may be a digital imaging device such as a photographic device or Flash LIDAR configured to take one or more digital images of all or part of machine 100. Scanning device 204 may then transmit the digital images to computing system 300 where the actual dimensions of machine 100 may be determined by known image and signal processing techniques. It is understood that scanning device 204 is not limited to the location illustrated in FIG. 2. For example, it is contemplated that scanning device 204 may be a mobile scanning device, wherein an operator/manager at worksite 200 may manually scan machines at worksite 200 in order to determine at least one actual dimension of the machines.

It is contemplated that scanning device 204 may also be used to identify a particular machine or type of machine and determine, based on the identity of the machine or type of machine, expected and/or previously recorded dimensions of machine 100. For example, scanning device 204 may scan a barcode or an identification number attached to and/or associated with machine 100. Scanning device 204 may transmit the scanned information to an associated Central Processing Unit (CPU) of computing system 300 so as to identify machine 100. It is further contemplated that an operator may input an identification number associated with machine 100 into an input device associated with computing system 300 so as to identify machine 100. In yet another embodiment, it is contemplated that machine 100 may electronically transmit identifying information to computing system 300.

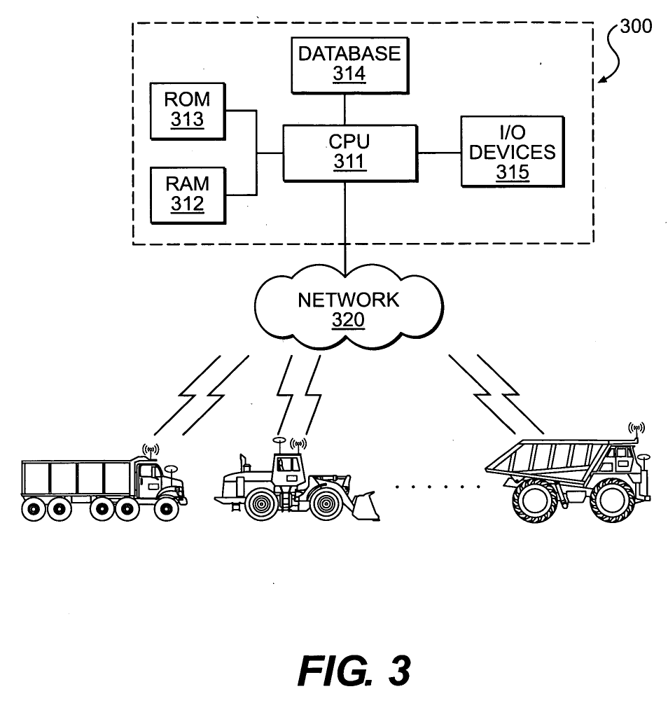

FIG. 3 illustrates an exemplary computing system 300 which may be associated with worksite 200. Computing system 300 may be configured to identify the size and type of machine 100 (and modifications associated therewith) operating within worksite 200, and to update other machines at worksite 200 with the modifications (i.e., one or more actual dimensions of machine 100). For example, after scanning device 204 scans machine 100, scanning device 204 may transmit information indicative of the scan to an associated CPU of computing system 300. The CPU may then compare the actual dimension(s) of machine 100 to at least one previously known dimension(s) of machine 100. If the difference between the actual dimension(s) of machine 100 is not within a threshold range of previously known dimension(s) of machine 100, computing system 300 may store the actual dimension(s), and update other machines operating within worksite 200 with the actual dimension(s) of machine 100. The threshold range may comprise an upper and lower threshold value, such that actual dimensions that are larger or smaller than the previously known dimensions may be taken into consideration. By defining a threshold range about the previously known dimension(s), machines with acceptable deviations in dimensions may be permitted to enter worksite 200, while excluding those machines that have unacceptable deviations in machine dimensions. Accordingly, the effect of small errors in dimensional calculations due, for example, to a calibration error associated with scanning device 204, may be mitigated. It is contemplated that the threshold range may be set and changed as desired.

If the difference between the actual dimension(s) of machine 100 is not within a threshold range of previously known dimension(s) of machine 100, computing system 300 may flag and/or schedule machine 100 for maintenance so that a manager of worksite 200 and/or an operator of machine 100 may determine if machine 100 needs repair. For example, it is contemplated that unexpected changes in the dimensions of machine 100 may be caused by damage to the machine. As an example, if the scanned information associated with machine 100 indicates that the width of machine 100 has unexpectedly changed from a previous set of scanned information, such a change may be indicative of an operation problem with the machine (e.g., a physical component of the machine may be out of alignment). Therefore, flagging machine 100 for maintenance may allow an operator or manager to identify and fix these types of problems. Moreover, if the difference between the actual dimension(s) of machine 100 is not within a threshold range of a previously known dimension(s) of machine 100, machine 100 may not be allowed to enter worksite 200. It is contemplated that, if after machine 100 goes through maintenance, a problem with machine 100 cannot be found, it may be determined that scanning device 204 needs to be recalibrated or replaced.

As illustrated in FIG. 3, computing system 300 may be communicatively coupled to a network 320 so that computing system 300 may transmit information indicative of the actual dimensions of machine 100 to other machines at worksite 200. Computing system 300 may include one or more hardware and/or software components such as, for example, a CPU 311, a random access memory (RAM) module 312, a read-only memory (ROM) module 313, a database 314, and one or more input/output (I/O) devices 315. Additionally, computing system 300 may include one or more software components or applications to perform specific processing and analysis functions associated with the disclosed embodiments. Computing system 300 may include, for example, a mainframe, a server, a desktop, a laptop, and the like.

CPU 311 may include one or more processors, each configured to execute instructions and process data to perform functions associated with computing system 300. Database 314 may include one or more analysis tools for analyzing information within database 314. Database 314 may be configured as a relational database, a distributed database, or any other suitable database format. Database 314 may include one or more software and/or hardware components that store, sort, filter, and/or arrange actual and/or previously known dimensions of machine 100. Database 314 may store additional and/or different information than that listed above.

I/O devices 315 may include a plurality of components configured to allow for the communication of information between computing system 300 and an operator of computing system 300. For example, one of I/O devices 315 may be configured to alert an operator if at least one actual dimension of machine 100 is not within a threshold range of at least one previously known dimension of machine 100. As such, I/O devices 315 may include one or more displays or other peripheral devices such as, for example, a printer, a camera, a microphone, a speaker system, an electronic tablet, or any other suitable type of input/output device. I/O devices 315 may additionally include a console with an integrated keyboard and mouse to allow a user to input parameters associated with computing system 300. Computing system 300 may include additional, fewer, and/or different components than those listed above and it is understood that the components listed above are exemplary only and not intended to be limiting.

As explained, network 320 may be coupled to computing system 300 to allow CPU 311 to communicate with a plurality of machines at worksite 200. In one embodiment, if it is determined that machine 100 has been modified so that its dimensions have changed, CPU 311 may store the actual dimension(s) of machine 100 in database 314, and may then use network 320 to transmit the actual dimensions of machine 100 to other machines at worksite 200. In this way, all machines at worksite 200 may be updated with the actual dimension(s) of all other machines at worksite 200. Network 320 may embody any appropriate communication network allowing communication between or among one or more entities. Network 320 may include, for example, the Internet, a local area network, a workstation peer-to-peer network, a direct link network, a wireless network, or any other suitable wired and/or wireless communication platform.

It is contemplated that network 320 and computing system 300 may further cooperate to verify the accuracy of the location coordinates that GPS antenna 104 receives from a plurality of Global Positioning Satellites. For example, when machine 100 enters worksite 200, controller 106 of machine 100 may, via wireless communication device 102, transmit location coordinates that GPS antenna 104 is receiving from a plurality of Global Positioning Satellites to network 320. Network 320 may forward the transmitted location coordinates to CPU 311. CPU 311 may retrieve known location coordinates of the actual location of machine 100. For example, if machine 100 is at a worksite entrance, CPU 311 may retrieve the known location coordinates of the worksite entrance. CPU 311 may then compare the known location coordinates with the transmitted location coordinates from machine 100. If, based on the comparison, CPU 311 determines that the known location coordinates are not within a threshold range of the transmitted location coordinates from machine 100, CPU 311 may flag machine 100 for maintenance. In some embodiments, CPU 311 may alert a manager of the discrepancy between the two sets of location coordinates, so that the manager may decide whether to allow machine 100 to enter worksite 200.

### INDUSTRIAL APPLICABILITY

The presently disclosed system and method for identifying machines and modifications made to machines may be employed to enhance site awareness systems, obstacle detection systems, and/or collision avoidance systems associated with a work environment. More specifically, processes and features associated with the disclosed embodiments may detect machine dimensions and store and/or update machine dimensions in a site awareness server. The site awareness server may distribute the machine dimensions to update obstacle detection and/or collision avoidance software associated with one or more machines in the work environment. As a result, the systems and methods described herein may predict operational conflicts associated with a machine operating in the work environment, and take the appropriate measures to resolve such conflicts during the operation of the machine in the work environment.

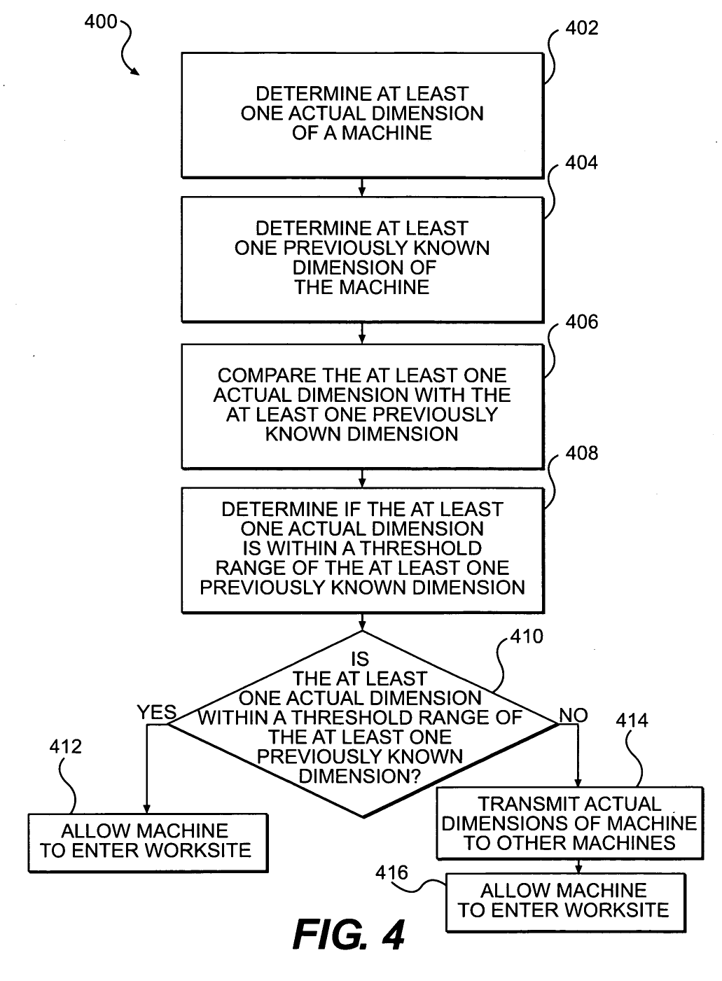

FIG. 4 illustrates a flowchart 400 depicting a method of using computing system 300 at worksite 200 to identify machines and modifications made to machines. The method in flowchart 400 may include determining at least one actual dimension of machine 100 (Step 402). As an example, as machine 100 enters worksite 200, machine 100 may be scanned by scanning device 204. In one embodiment, scanning device 204 may be configured to emit electromagnetic waves, e.g., radio waves or microwaves, to scan all or part of machine 100. Information corresponding to the scanning of machine 100 may be transmitted to CPU 311 via network 320. CPU 311 may then determine at least one actual dimension of machine 100 by, for example, using information indicative of the propagation of the electromagnetic waves. In another embodiment, scanning device 204 may be configured to take one or more digital pictures of machine 100. Information indicative of the digital picture(s) may then be transmitted to CPU 311 where the at least one actual dimension of machine 100 may be determined by known image and signal processing techniques.

The method in flowchart 400 may further include determining at least one previously known dimension of machine 100 (Step 404). For example, scanning device 204 may scan a barcode or an identification number attached to and/or associated with machine 100. Scanning device 204 may transmit the scanned information to computing system 300 so as to identify machine 100. It is further contemplated that an operator may input an identification number associated with machine 100 into an input device associated with computing system 300 so as to identify machine 100. In yet another embodiment, it is contemplated that machine 100 may electronically transmit identifying information to computing system 300. After machine 100 is identified, CPU 311 may search database 314 to determine if database 314 contains at least one previously known dimension of machine 100. It is contemplated that if at least one previously known dimension of machine 100 does not exist or cannot be found in database 314, CPU 311 may create and enter into database 314 the at least one actual dimension of machine 100, which would become the at least one previously known dimension of machine 100. It is further contemplated that database 314 may retain all previously known dimensions of machine 100. This may ensure that dimensional modifications that have been made to a machine over time may be saved and retrieved, as desired.

The method in flowchart 400 may further include comparing the at least one actual dimension of machine 100 with the at least one previously known dimension of machine 100 (Step 406). As an example, after the at least one actual dimension and the at least one previously known dimension of machine 100 have been determined by CPU 311, CPU 311 may compare the at least one actual dimension of the machine with the at least one previously known dimension of the machine. CPU 311 may then determine, based on the comparison, if the at least one actual dimension of machine 100 is within a threshold range of the at least one previously known dimension of machine 100 (Step 408). If the at least one actual dimension of machine 100 is within a threshold range of the at least one previously known dimension of machine 100 (Step 410, Yes), machine 100 may be allowed to enter worksite 200 (Step 412).

If the at least one actual dimension of machine 100 is not within a threshold range of the at least one previously known dimension of machine 100 (Step 410, No), CPU 311 may store the actual dimension(s) of machine 100 in database 314, and may then use network 320 to transmit the actual dimensions(s) of machine 100 to other machines at worksite 200 (Step 414). In this way, all machines at worksite 200 may be updated with the actual dimension(s) of all other machines at worksite 200. After all machines at worksite 200 are updated with the actual dimension(s) of machine 100, machine 100 may then be allowed to enter worksite 200 (Step 416). In some embodiments, if the difference between the actual dimension(s) of machine 100 is not within a threshold range of a previously known dimension(s) of machine 100, a manager at worksite 200 may not allow machine 100 to enter worksite 200.

Although the steps in flowchart 400 are described in relation to a particular worksite and particular machines, it is contemplated that the steps in flowchart 400 may be applicable to any working environment and any type and number of machines. Furthermore, the examples described in flowchart 400 are not intended to be limiting. For example, it is contemplated that the steps in flowchart 400 may consist of fewer or additional steps. It is further contemplated that the steps in flowchart 400 may be implemented in a different order than presented, or in any suitable manner such as, for example, continuously, periodically, individually repeated, etc.

It will be apparent to those skilled in the art that various modifications and variations can be made to the disclosed system and method. Other embodiments will be apparent to those skilled in the art from consideration of the specification and practice of the disclosed system and method. It is intended that the specification and examples be considered as exemplary only, with a true scope being indicated by the following claims.

What is claimed is:

1. A method for identifying modifications made to a machine, the method comprising:
determining, by a scanning device, at least one actual dimension of the machine;
determining at least one previously known dimension of the machine;
comparing the at least one actual dimension of the machine with the at least one previously known dimension of the machine; and
determining, based on the comparison, if the at least one actual dimension of the machine is within a threshold range of the at least one previously known dimension of the machine.

2. The method of claim 1, further comprising communicating the at least one actual dimension of the machine to other machines if the at least one actual dimension of the machine is not within a threshold range of the at least one previously known dimension of the machine.

3. The method of claim 1, further comprising scheduling the machine for maintenance if the at least one actual dimension of the machine is not within a threshold range of the at least one previously known dimension of the machine.

4. The method of claim 1, further comprising storing the at least one actual dimension of the machine in a database if the at least one actual dimension of the machine is not within a threshold range of the at least one previously known dimension of the machine.

5. The method of claim 1, wherein determining the at least one previously known dimension of the machine includes using the at least one actual dimension of the machine as the at least one previously known dimension of the machine if the at least one previously known dimension of the machine is not stored in a database associated with the scanning device.

6. The method of claim 1, further comprising receiving at least one location coordinate of the machine and determining if the at least one location coordinate is accurate.

7. A system for identifying modifications made to a machine, the system comprising:
a scanning device configured to scan the machine to determine at least one actual dimension of the machine;
a database in communication with the scanning device, the database configured to store at least one previously known dimension of the machine; and
a Central Processing Unit (CPU) in communication with the scanning device and the database, the CPU configured to:
compare the at least one actual dimension of the machine with the at least one previously known dimension of the machine; and
determine, based on the comparison, if the at least one actual dimension of the machine is within a threshold range of the at least one previously known dimension of the machine.

8. The system of claim 7, further comprising a communications network coupled to the CPU, wherein the CPU is configured to use the communications network to communicate to other machines the at least one actual dimension of the machine.

9. The system of claim 7, wherein the scanning device is configured to emit electromagnetic waves and the CPU is configured to determine the at least one actual dimension of the machine based on propagation characteristics of the electromagnetic waves.

10. The system of claim 7, wherein the scanning device is configured to take a digital picture of the machine.

11. The system of claim 7, wherein the CPU is further configured to schedule the machine for maintenance if the at least one actual dimension of the machine is not within a threshold range of the at least one previously known dimension of the machine.

12. The system of claim 7, wherein the scanning device is a mobile scanning device.

13. The system of claim 7, wherein the CPU is further configured to receive at least one location coordinate of the machine and determine if the at least one location coordinate is accurate.

14. A worksite configured to identify modifications made to machines, the worksite comprising:
a plurality of machines;
a scanning device configured to scan each of the plurality of machines to determine at least one actual dimension of each of the plurality of machines;
a database associated with the scanning device, the database configured to store at least one previously known dimension of each of the plurality of machines; and
a Central Processing Unit (CPU) associated with the scanning device and the database, the CPU configured to:
compare the at least one actual dimension of at least one of the plurality of machines with the at least one previously known dimension of the at least one of the plurality of machines; and
determine, based on the comparison, for the at least one of the plurality of machines, if the at least one actual dimension of the at least one of the plurality of machines is within a threshold range of the at least one previously known dimension of the at least one of the plurality of machines.

15. The worksite of claim 14, further comprising a communications network coupled to the CPU, wherein the CPU is further configured to use the communications network to communicate to other machines the at least one actual dimension of each of the plurality of machines.

16. The worksite of claim 14, wherein the scanning device is configured to emit electromagnetic waves and the CPU is configured to determine the at least one actual dimension of each of the plurality of machines based on propagation characteristics of the electromagnetic waves.

17. The worksite of claim 14, wherein the scanning device is configured to take a digital picture of each of the plurality of machines.

18. The worksite of claim 14, wherein the CPU is further configured to schedule each of the plurality of machines for maintenance.

19. The worksite of claim 14, wherein the scanning device is a mobile scanning device.

20. The worksite of claim 14, wherein the CPU is further configured to receive at least one location coordinate of at least one of the plurality of machines and determine if the at least one location coordinate is accurate.
